(19) United States
(12) Patent Application Publication
(10) Pub. No.: US 2002/0108586 A1
(43) Pub. Date: Aug. 15, 2002

(54) Fly mask

(76) Inventor: Jack L. Martin, Libertyville, IL (US)

Correspondence Address: Trexler Bushnell Giangiorgi, Blackstone and Marr, Ltd., 105 West Adams Street, 36th Floor, Chicago, IL, 60603, US

(21) Appl. No.: 09/784,461

(22) Filed: Feb. 15, 2001

(51) Int. Cl. A01K 13/00

(52) U.S. Cl. 119/850

(57) ABSTRACT

The present invention provides a novel protective mask to be worn by an animal. The mask includes a viewing portion made from a mesh material and a fitted portion made from a strechable material. The mask protects the animals eyes from flies and other insects.

### BACKGROUND OF THE INVENTION

This invention is generally directed to a protective mask for animals. More particularly, the invention contemplates a mask to protect an animals eyes and ears from flies and other insects.

It has long been known that flies and insects are an irritation to certain animals and in particular horses. More specifically, horses eyes and ears are vulnerable to irritation by insects. Some types of flies for example, feed on liquid substances around the animal's eyes, spreading bacterial organisms which can cause infection. As the eyes become irritated the animal's eyes begin to tear and the tearing attracts more flies. The flies then follow the path of tearing to the animal's eyes, further increasing the spread of infection. Infections place the health of the animal's eyes at risk and in severe cases blindness can occur.

In the same manner, insects are attracted to fluid and other forms of discharge from animal's ears. The insects bring bacterial organisms to the ears and in some cases even bite the interior surface of the animal's ears, causing openings in the skin which can become infected.

It is therefore desirable to protect the horse's eyes and ears from these insects to avoid infection and to provide comfort to the animal.

Throughout the years, many different types of protective head gear have been designed to protect horses eyes and ears from insects. Some of these head gear designs utilize tassels which hang in front of the horse's eyes and simply whisk flies from the horse's eyes. Others such as the designs disclosed in U.S. Pat. No. 4,662,156; U.S. Pat. No. 5,440,864 and U.S. Pat. No. 5,345,751 provide a mesh which covers the horse's eyes. In some varieties, the mesh, which provides the viewing portion of the mask, is designed to be secured to the bridle or halter. In others, the viewing portion of the mask is attached to the remainder of the mask which is designed to attach around the horse's muzzle and behind the horse's ears. Rather than using a mesh viewing screen, another type of mask, disclosed in U.S. Pat. No. 5,341,627, employs an upstanding annular collar surrounding each eye hole and removably attached cup-shaped eye covers. None of the designs of the patents discussed above, however, provide protection to the horse's ears.

The tassel design described above allows the insects to approach the horse's eyes. When the horse responds to the irritation caused by the insect, the horse shakes its head and the tassels whisk the insects away. An undesirable result of this design is that the insect is allowed access to the animal's eyes. The remaining mask designs described above, require a snug fit around the horse's muzzle and behind the horse's ears to prevent insects from crawling under the mask and gaining access to the horse's eyes. Because horse's heads vary in size and shape, many of the designs use adjustable straps to achieve this snug fit. The straps are generally located around the horse's muzzle and behind the horse's ears.

In order to effectively prevent the intrusion of insects into the mask, the straps need to be adjusted tightly. The tightly adjusted straps can cause discomfort and irritation to the horse's skin. Often the masks employ a plush material around the mask openings so that when the straps are tightened the plush material provides cushioning to prevent irritation to the skin. The plush material is also used to provide an additional barrier to prevent insects from entering the mask. However, because the plush material breaks down when it is exposed to the elements such as sun and rain or sweat from the animal, it soon becomes an ineffective barrier to insects. U.S. Pat. No. 5,440,864 uses neoprene material to trim the mask opening rather than a plush material. The neoprene trim is capable of withstanding the elements and does not breakdown as quickly as the plush materials. The neoprene trim is however somewhat rigid and can, when the straps are tightened, cause discomfort to the animal. Another disadvantage of the adjustable straps is that if they are pulled too tightly around the horse's muzzle the horse will loose mobility of its jaw and head and the horse will be uncomfortable.

Another disadvantage in the construction of the masks such as those described above relates to the stitching of the fabric required to obtain the appropriate shape. The presence of these seams can cause irritation to the horse's skin where the seams contact the horse. Often when a horse experiences this type of irritation on their skin it rubs the irritated area against other nearby objects. In addition to the possibility of injuring itself during rubbing, the rubbing causes further irritation to the skin which can lead to sores on the horse's skin. The sores allow for the possibility of infection and possibly the formation of scar tissue. In some designs, such as the one disclosed in U.S. Pat. No. 5,345,751, the manufacturing process includes covering every edge of the screen material with padding material to avoid irritation of the horse's skin. This step, of course, adds cost to the production of the mask. It is therefore desirable to provide a mask with a limited number of seams and where seams do occur it is desirable that the seams are as smooth and flexible as possible. Unlike a stiff seam which can dig or jab into the horse's skin, a flexible seam will comfortably contour the horse's body. Because it is intended that the mask be worn throughout many of its daily activities such as grazing, eating and drinking, it is important that mobility of the horse's jaw and head in general is maintained.

U.S. Pat. No. 5,440,864 attempts to alleviate the discomfort caused by tightly adjusted straps, by attaching the fastening strap to a piece of elastic. The use of a piece of elastic does provide more flexibility while maintaining a snug fit and thus allows for greater mobility of the jaw. However, a mask with even greater flexibility is still desired.

Finally, it should be noted that some masks also provide a break-away safety feature. When a mask is worn by a horse, there is a potential that the mask can become caught on a nearby object. This potential is increased when plush material is utilized around the edges of the mask because the plush material protrudes away from the horse's skin. If the mask is caught on a pole, fence or other object, the horse will likely struggle or pull to free himself, the “break-away” acts to release the mask so that the horse is not further injured as he struggles. It is therefore desirable that the mask can be easily removed from the horse's head if it becomes caught.

As will become clear upon a reading of the attached specification in combination with a study of the drawings the present invention provides a protective mask which overcomes the problems presented in the prior art and which provides additional advantages over the prior art.

### OBJECTS AND SUMMARY OF THE INVENTION

A general object of the present invention is to provide an improved mask which protects an animal's eyes and ears from molestation by insects.

Another object of the present invention is to provide a protective mask which adjusts easily to provide a proper fit for animals with heads of different sizes and shapes.

A further object of the present invention is to provide a protective mask which fits properly without the use of straps.

A further object of the present invention is to provide a protective mask with flexibility to allow for movement of the animal's jaw and head.

A further object of the present invention is to provide a protective mask without seams which irritate the animal's skin.

A further object of the present invention is to provide a mask which is independently securable to a horse with out the need to be affixed to a bridle or halter.

A further object of the present invention is to provide a protective mask which can be economically manufactured.

A further object of the present invention is to provide a durable protective mask which can be easily washed.

Briefly, and in accordance with the foregoing, the present invention comprises a protective mask made from a combination of stretchable fabric and a mesh fabric. The mesh fabric protects the animal's eyes from insects while allowing the animal visibility and the stretchable fabric provides a snug fit for heads of different sizes and shapes. This snug fit prevents the intrusion of insects without the need for straps and does not hinder movement of the animal's jaw or head. Due to the pliable nature of the fabric, seams created during construction of the mask do not provide a source of irritation to the animal's skin. The mask can be economically manufactured, is durable and can be easily cleaned.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a perspective view of a first embodiment of the mask;

FIG. 2 is a left side elevational view of a first embodiment of the mask;

FIG. 3 is a front elevational view of a first embodiment of the mask;

FIG. 4 is a perspective view of a second embodiment of the mask;

FIG. 5 is a perspective view of a third embodiment of the mask;

FIG. 6 is a cross-sectional view of the mask shown in FIG. 3 at line 6-6;

FIG. 7 is a cross-sectional view of the earpiece shown in FIG. 3 at line 7-7;

FIG. 8 is a cross-sectional view of the earpiece shown in FIG. 5 at line 8-8.

### DETAILED DESCRIPTION OF THE ILLUSTRATED EMBODIMENT

While the invention may be susceptible to embodiment in different forms, there is shown in the drawings, and herein will be described in detail, specific embodiments with the understanding that the present disclosure is to be considered an exemplification of the principles of the invention, and is not intended to limit the invention to that as illustrated and described herein.

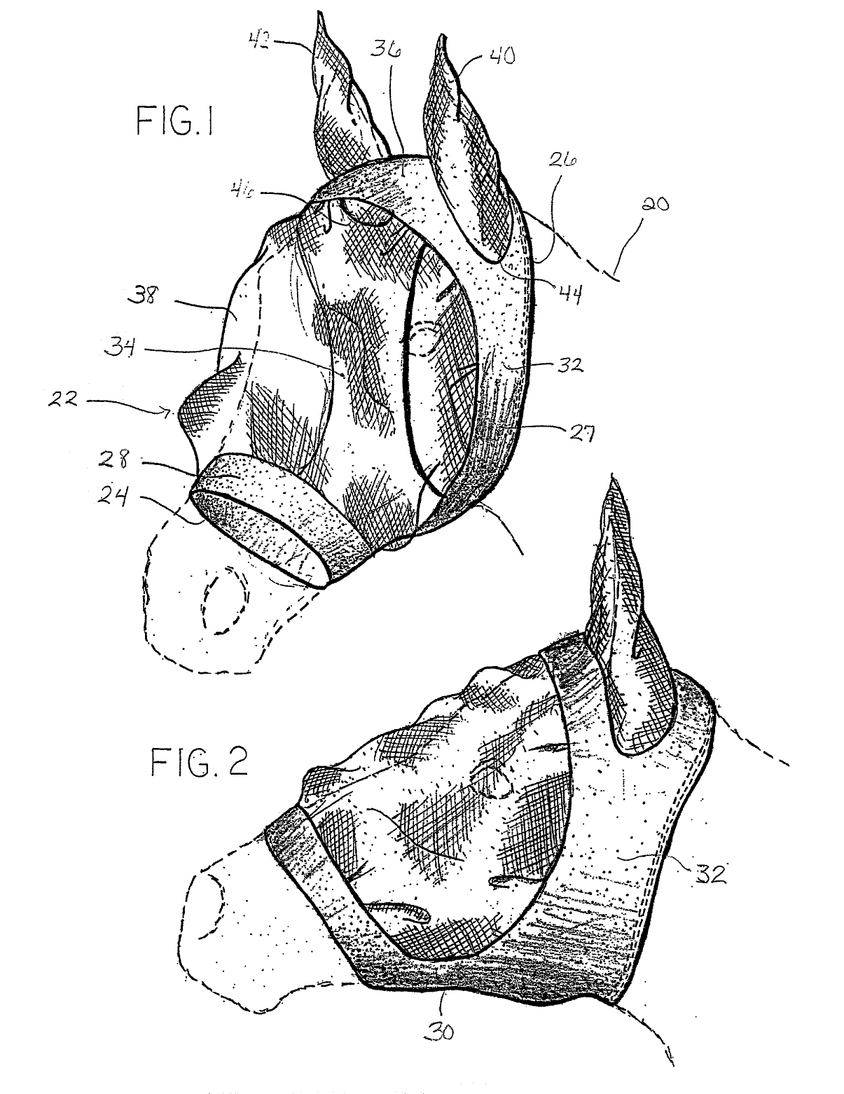

The invention is a protective mask to be placed on an animal's head so as to protect its head, eyes and ears from insects. An alternative embodiment of the invention is designed to offer protection only to the horse's head and eyes. FIG. 1 shows a portion of a horse 20 to illustrate the manner in which the mask 22 is to be worn. The construction of the mask 22 is generally tubular shaped with a nose opening 24 at one end and a head opening 26 at the opposite end. Generally, the mask includes a fitted portion 27, a viewing portion 38 and ear covers 40, 42. The fitted portion of the mask includes a nose part 28, a chin part 30, a left cheek part 32, a right cheek part 34, and a forehead part 36. The chin part 30 and the left cheek part 32 can best be seen in the left side elevational view shown in FIG. 2. Although it is fully contemplated that the fitted portion of the mask can be constructed from a single piece of stretchable fabric, different parts of the fitted portion have been defined for purposes of describing the characteristics of the mask.

The fitted portion 27 of the mask is constructed from a light weight, stretchable, breathable fabric such as lycra® or spandex®. The viewing portion 38 and the ear covers 40, 42 are made from a mesh material. The mesh material allows the horse to see through the viewing portion and provides air flow to the face and ears.

The nose part 28 of the mask, which defines the nose opening 24, encircles the horse nose. The nose part 28 meets the chin part 30 of the mask at the under side of the horse jaw. The chin part 30 of the mask 22 extends from the nose part 28, along the horse's chin, to the left cheek part 32 and the right cheek part 34. The left 32 and right 34 cheek part extend from the chin part 30 toward the head opening 26 and upwards toward the horse's forehead at which point the cheek part 32, 34 meet the forehead portion 36. Generally circular shaped ear openings 44, 46 are provided in the forehead part 36 of the fitted portion 27, allowing the animal's ears to protrude through the forehead part 36 of the mask 22. The forehead part 36 lies between the animals ears and reaches from the viewing portion 38 to the head opening 26.

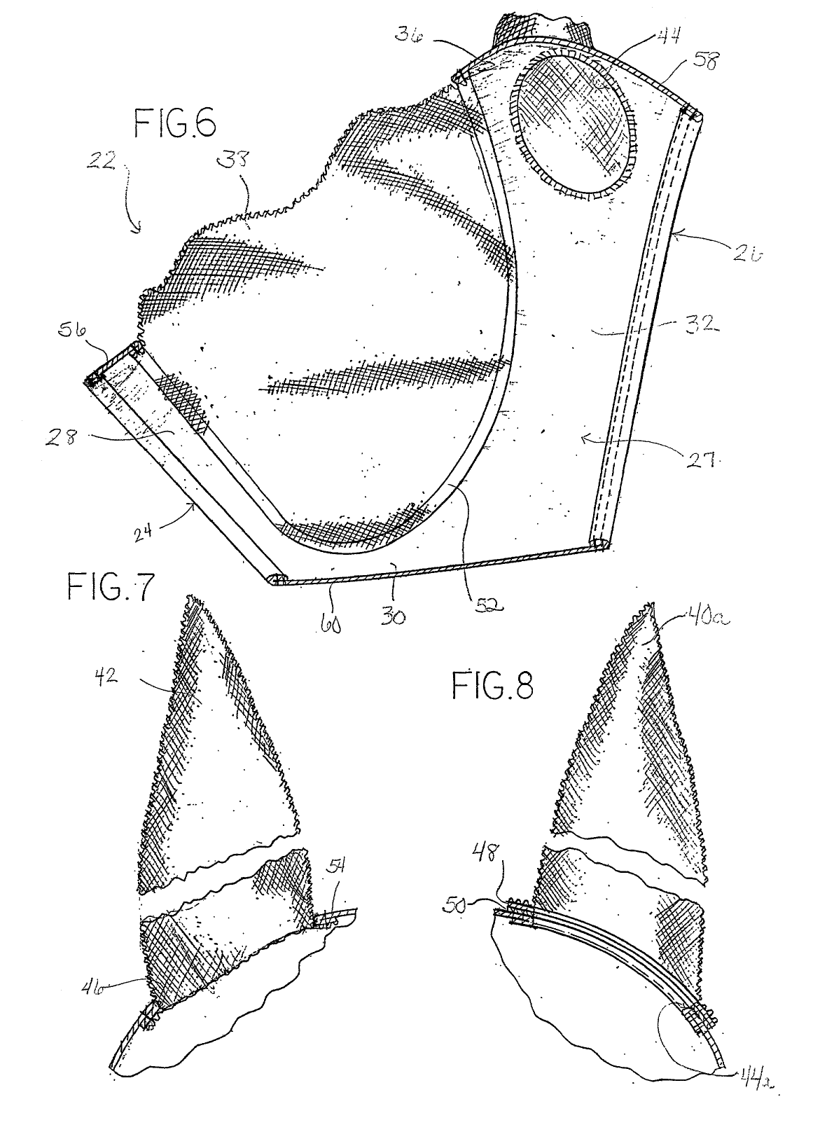

The viewing portion 38 of the mask 22 extends from the nose part 28 to the forehead part 36 and meets with the cheek portions 32, 34 and the chin part 30 so as to cover the animal's face. The fitted portion 27 of the mask 22 generally surrounds the perimeter 52 of the viewing portion 38 of the mask 22. Stitching around the perimeter 52 of the viewing portion 38 provides the attachment of the viewing portion 38 to the fitted portion 27 (See FIG. 6). Ear covers 40, 42 are generally cone shaped and protrude outward from the ear openings 44, 46. As shown in FIG. 7, the fabric is folded around the circumference of the ear opening 46 and circular edge the ear cover 42 is attached to the fitted portion 27 through stitches 54. The ear cover 40 is attached to the ear opening 44 of the fitted portion 27 of the mask in a similar manner.

The fitted portion 27 of the mask 22 can be made from any number of pieces of fabric. The preferred embodiment of the mask as shown in FIG. 6 is constructed using two pieces of stretchable fabric whose patterns are mirror images of one another, one of which is shown. The fabric is rolled and stitched to form the nose opening 24 and the head opening 26. The fabric pieces are joined with stitching to form a nose seam 56, and forehead seam 58, and a chin seam 60. This manner of construction provides a simple construction process with a minimal number of seams.

As noted above, the viewing portion 38 of the mask is secured to the nose 28, chin 30, cheek 32, 34 and forehead 36 parts through the use of stitching. Due to the pliable nature of the stretchable fabric and the relatively minimal thickness of the fabric, the seams formed do not jab into the horse's skin but rather, conform to the horses body. Thus, the seams do not require additional padding to avoid irritation to the horse's skin, reducing the cost of producing the mask.

The mask is placed on the horse by gently stretching the mask 22, passing the horse's nose through the head opening 26 and then through the nose opening 24. The nose opening 24 is positioned around the horse's muzzle between the nostrils and the eyes. The head opening 26 is then pulled over and past the horse's ears and the ears are positioned within the ear openings 44, 46. When the stretching force is released a snug fit is achieved at the nose opening 24 and the head opening 26.

The size of the mask selected will be such that the circumference of the nose opening 24 is slightly smaller than the circumference of the horse's muzzle and the circumference of the head opening 26 is slightly smaller than the circumference of the horse's head at a point just behind the horse's ears. Because the mask 22 is constructed from a stretchable fabric, the selection of a mask size in this manner will provide a mask which fits snugly around the muzzle and the head and therefore prevents insects from entering the mask 22. The mask 22 itself acts as this barrier without the need for adding a plush or neoprene type trim. The stretchable fabric used for the remaining portions of the mask provides a snug fit and at the same time does not restrict movement of the horse's jaw or head. The flexibility of the mask allows the animal to comfortably wear the mask without interruption to its daily activities such as grazing, drinking and riding. The mask is also self adjusting and therefore no straps are needed to compensate for heads of different sizes and shape. The fitted portion of the mask is designed such that gentle pressure is evenly applied around the horse's muzzle and head. This gentle pressure not only holds the mask in place on the horse's head but it also provides an effective barrier to the insects. Because no straps or trim are used in the construction of the mask, the mask is less expensive.

The mask 22 can be worn without attachment to any other apparatus. However, if desired additional apparatus such as a bridle or halter can be used along with the mask. Because the mask is extremely light weight and thin, the additional apparatus is worn over the mask and its use is not affected by the mask 22.

Additional features are not necessary for the mask to be used safely. First, the thin profile of the mask, unlike those which employ plush material around the edges, reduces the possibility of the mask becoming caught on a nearby object. Secondly, if the mask were to become caught, pulling by the horse would likely result in the simply sliding the mask off the horse's head. If the mask did not slide of the horses head as the horse pulled. the mask will simply tear off.

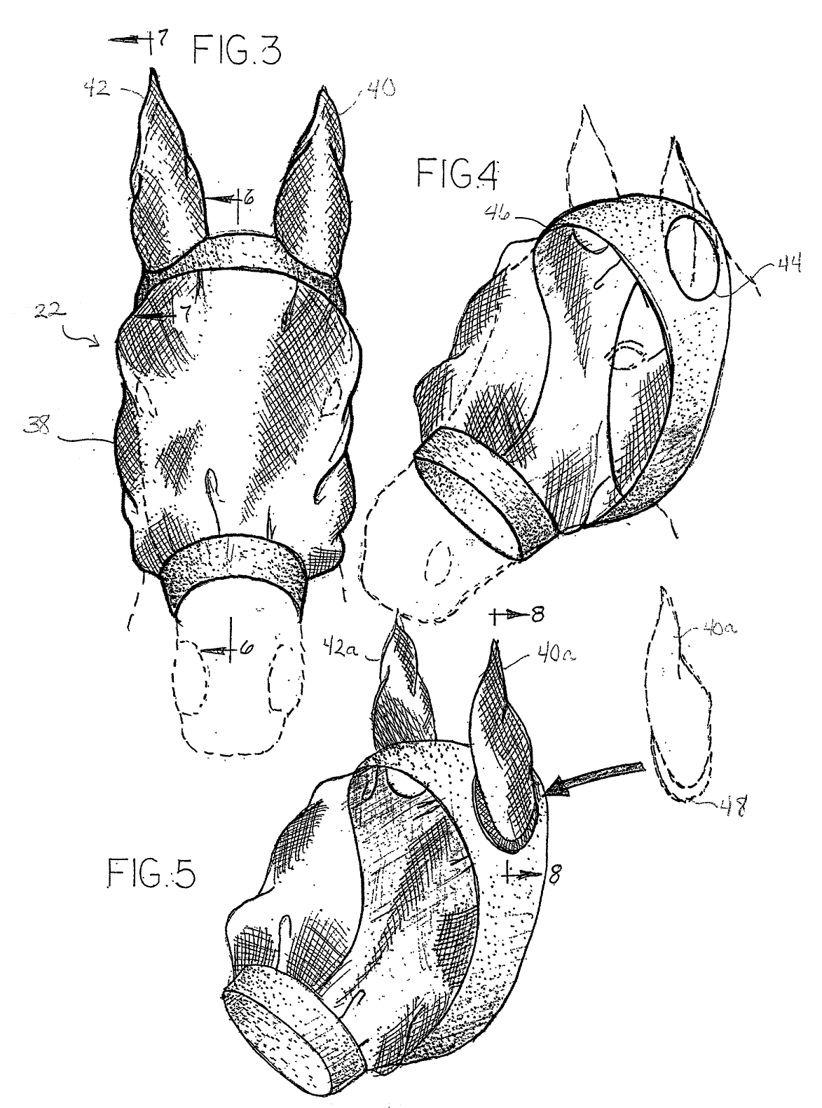

An alternative embodiment allows the ears to remain uncovered if desired. This embodiment is shown in FIG. 4. In this embodiment ear covers are not attached to the ear openings 44, 46. A mask of this type could be used when there is no concern about protecting the horse's ear from insects. A third embodiment is shown in FIG. 5. This embodiment provides removable ear covers 40a, 42a. The removable ear covers 40a and 42a are similar to the ear covers 40 and 42 with the addition of a hook and loop type fastener, such as the hook and loop fastener sold under the trademark Velcro®, to the circular edge of the cone as shown in FIG. 8. The mating surfaces of fastener are a loop surface and a hook surface.

The embodiment of FIG. 5 provides versatility for the user. The hook portion 48 of the hook and loop fastener is attached to the ear cover 40a by sewing the hook portion 48 of the fastener around the circular edge of the ear cover 40a. The mating loop portion 50 of the hook and loop fastener is attached to the ear opening 44a by sewing the loop portion 50 to the circular edge of ear opening 44a. If desired, the ears can be covered simply by placing the mask on the horse's head, positioning the ear covers over the horse's ears, aligning the hook portion 48 with the loop portion 50 of the fastener, and applying pressure to the fastener portions 48, 50 so as to mate the hook portion with the loop portion. Removal of the ear covers 40a, 42a can easily be accomplished by pulling the hook fastener 48 away from the loop fastener 50.

Although in the embodiment shown and described the loop fastener 50 is sewn to the outer surface of the ear opening 44a and the mating surface is directed away from the horse's skin, it is also understood that the loop fastener 50 could be sewn to the ear opening 44a such that the mating surface of the loop fastener is directed toward's the horse's skin. In this embodiment the hook fastener 48 would be attached to the ear cover 40a in a manner such that attaching surface of the hook fastener 48 would be directed away from the horse's skin. This embodiment would allow for the mating of the two surfaces underneath the fitted portion of the mask.

While preferred embodiments of the present invention are shown and described, it is envisioned that those skilled in the art may devise various modifications of the present invention without departing from the spirit and scope of the appended claims.

While much of the description and the drawing reference use of the mask for horses. Many different animals can benefit from the use of the mask described. For example, cattle often encounter similar problems with the irritation to the eyes form flies and other insects. The mask described above could be worn by cattle as easily as it can be worn by horses.

The invention claimed is:

1. A protective animal mask, comprising a viewing portion constructed from a mesh material; a fitted portion constructed from a stretchable material; wherein said fitted portion is attached to the perimeter of said viewing portion; wherein said fitted portion defines at least an appropriately sized head opening.

2. A protective mask as defined in claim 1 further including; ear openings and ear covers attached to said ear openings.

3. A protective mask as defined in claim 2 further including; ear covers removably attached to said ear openings.

4. A protective mask as defined in claim 3; further including fastening means attached to said ear openings and fastening means attached to said ear covers; wherein said fastening means attached to said ear openings mates with said fastening means attached to said ear covers.

5. An animal mask comprising:
covering means for protecting an animal's eyes against insect molestation without significantly impairing vision nor preventing sufficient air flow; and
fitting means, operatively fastened to said covering means, for elastically securing said covering means to an animal in a manner which is comfortable for the animal and prevents insects from gaining access below the covering means.
